(19) United States
(12) Patent Application Publication
(10) Pub. No.: US 2008/0122808 A1
(43) Pub. Date: May 29, 2008

(54) Scroll Wheel Input Device

(76) Inventor: Kuo-An Huang, Taipei (TW)

Correspondence Address: WPAT, PC, 7225 BEVERLY ST., ANNANDALE, VA, 22003, US

(21) Appl. No.: 11/564,380

(22) Filed: Nov. 29, 2006

(51) Int. Cl. G06F 3/033

(52) U.S. Cl. 345/184

(57) ABSTRACT

An objective of the present invention provides a scroll wheel input device that comprises: a scroll wheel providing a longitudinal scrolling and a lateral triggering, wherein the longitudinal scrolling provides a first dimension selection and the lateral triggering provides a second dimension selection; and a plurality of display elements comprising a multiple sets of first dimension display element group. Each of the first dimension display element group comprises at least one second dimension display element, wherein the first dimension selection is made by switching among the different first dimension display element groups via the longitudinal scrolling while the second dimension selection is made by switching among the at least one second dimension display element in the switched first dimension display element group via the lateral triggering.

### BACKGROUND OF THE INVENTION

1. Field of the Invention

The present invention generally relates to an input interface, and more particularly to an input interface combining a scroll wheel and display elements.

2. Description of the Prior Art

Generally, keys can be categorized into two types in terms of their usage: single keys and composite keys. When a key is used as a single key, signal representing that key will be sent out upon triggering of the key. This is a single dimensional key triggering. When a key is used as a composite key, a plurality of key triggering take place before a signal representing the plurality of key triggering is sent out, wherein the plurality of triggering can be achieved by multiple triggering of the same key, e.g. repeatedly depressing the same key two or three times for sending respective signals with different meanings. Alternatively, the plurality of triggering can be achieved by continuously triggering a combination of different keys, e.g. triggering a key that represents a particular group then triggering a specific key in that group to send out a signal that represents the combination of these two keys or simultaneously depressing different keys to send out a signal that represents the combination of these keys.

In the case of composite keys, there must be a plurality of keys that are classified into a plurality of key groups. A key may be incorporated into more than one key group. Each of the key groups is represented by a single key or a composite key. Additionally, a key group may include a plurality of child key groups, and each of the child key groups may further include a plurality of grandchild key groups. In other words, the triggering of a composite key may be regarded as a multidimensional triggering. For example, a first dimension triggering may be the triggering of a key representing a particular key group; a second dimension triggering may be the triggering of a key representing a particular child key group in that key group; a third dimensional triggering may be the triggering of a key representing a particular grandchild key group in said child group and so on. The employment of such composite keys requires a smaller number of keys, as the possible combinations of the various keys are much greater than the sum of the keys. This reduces the necessary number of keys and thus saves cost.

However, under the dimensional constraint of many hand-held devices, keys have to be downsized and more densely arranged on a limited space of the small hand-held devices. As can be seen from FIG. 1, in addition to buttons, a lot of texts and symbols for indicating functions are closely provided on a remote controller. A user may easily push the wrong button since the bottoms are both visually and operationally challenging. If the user is unfamiliar with the buttons, it may also be time consuming to find and determine the right key combination. Moreover, if a wrong key was depressed, time is spent on canceling the triggered key and/or waiting for a period of time before triggering again. When more trigger dimensions are involved, these problems may occur more often, which is both frustrating and time-consuming. Therefore, a design is needed to overcome these problems.

### SUMMARY OF THE INVENTION

In view of the descriptions in the background and requirements of particular interests in the industry, the present invention solves the problems of the prior art by providing a scroll wheel input device.

One objective of the present invention is to provide a scroll wheel input device, comprising: a scroll wheel providing a longitudinal scrolling and a lateral triggering, wherein the longitudinal scrolling provides a first dimension selection and the lateral triggering provides a second dimension selection; and a plurality of display elements comprising a multiple sets of first dimension display element group, each of the first dimension display element group comprising at least one second dimension display element, wherein the first dimension selection is made by switching among the different first dimension display element groups via the longitudinal scrolling while the second dimension selection is made by switching among the at least one second dimension display element in the switched first dimension display element group via the lateral triggering.

Another objective of the present invention is to provide a scroll wheel controlling program stored in an input assembly with a processor. In order to make a scroll wheel an input selection device, the program allows the input assembly with the processor to be devices that have the following functionalities: providing a scroll wheel input device that allows a longitudinal scrolling and a lateral triggering, wherein the longitudinal scrolling provides a first dimension selection while the lateral triggering provides a second dimension selection; providing a device that switches between a multiple sets of first dimension display element groups based on the first dimension selection, wherein the multiple sets of the first dimension display element groups are included in a plurality of display elements, and each set of the first dimension display element groups comprising at least one second dimension display element; and providing a device that switches between the at least one second dimension display element of a switched first dimension display element group based on the second dimension selection.

Yet another objective of the present invention is to provide a recording medium stored with a scroll wheel controlling program. In order to make a scroll wheel an input selection device, the program allows an input assembly with a processor to be devices that have the following functionalities: providing a scroll wheel input device that allows a longitudinal scrolling and a lateral triggering, wherein the longitudinal scrolling provides a first dimension selection while the lateral triggering provides a second dimension selection; providing a device that switches between a multiple sets of first dimension display element groups based on the first dimension selection, wherein the multiple sets of the first dimension display element groups are included in a plurality of display elements, and each set of the first dimension display element groups comprising at least one second dimension display element; and providing a device that switches between the at least one second dimension display element of a switched first dimension display element group based on the second dimension selection.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a traditional remote controller without scroll wheel;

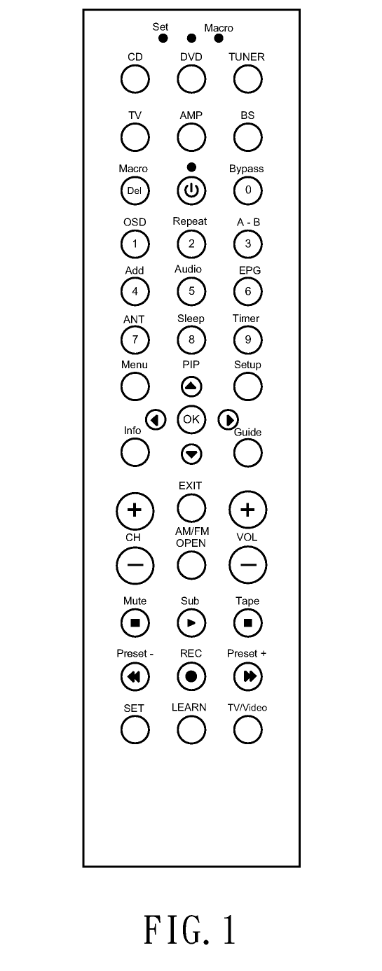

FIGS. 2A and 2B are schematic diagrams depicting a scroll wheel;

FIG. 3 is a schematic diagram showing display groups of a first embodiment of the present invention;

FIG. 4 is a schematic diagram showing display groups of a second embodiment of the present invention; and

FIG. 5 is a schematic diagram showing display groups of a third embodiment of the present invention.

### DETAILED DESCRIPTION OF THE PREFERRED EMBODIMENTS

The present invention is directed to a scroll wheel input device. In order to fully understand the present invention, detailed steps and compositions thereof are described as follow. Obviously, implementations of the present invention are not limited to specific details known by those skilled in the art of input devices. On the other hand, well-known compositions and steps are not described in details in order not to unnecessarily limit the present invention. The preferred embodiments of the present invention are described below. However, in addition to the detailed descriptions, the present invention can be broadly applied in other embodiments and the scope of the present invention is not limited to these, but rather is defined by the appended claims.

As described in the prior art, triggering of the keys may be single dimensional or multidimensional. In the case of single dimensional triggering, possibly-triggered keys may be incorporated in the same key group or child key group. In the case of multidimensional triggering, each key is classified in a key group or child key group in different dimensions. Selections of key groups or child key groups are made by triggering in different dimensions. Also, a key is selected in triggering of the last dimension (single dimension triggering). After the key is confirmed, a signal representing a multidimensional triggering is sent. The above confirmation can be made at the same time the key is triggered or can be made by retriggering of the key or by triggering of other keys.

The present invention proposes a device that combines a scroll wheel with display elements and the method thereof to replace a plurality of keys. The composite key combination described above can be represented by a composite of display elements. Triggering of the composite key combination can be indicated by displaying the display elements. In other words, by operating the scroll wheel, different dimension display element groups can indicate the selection of different dimension key groups, and the key selection and confirmation are done in the final dimension.

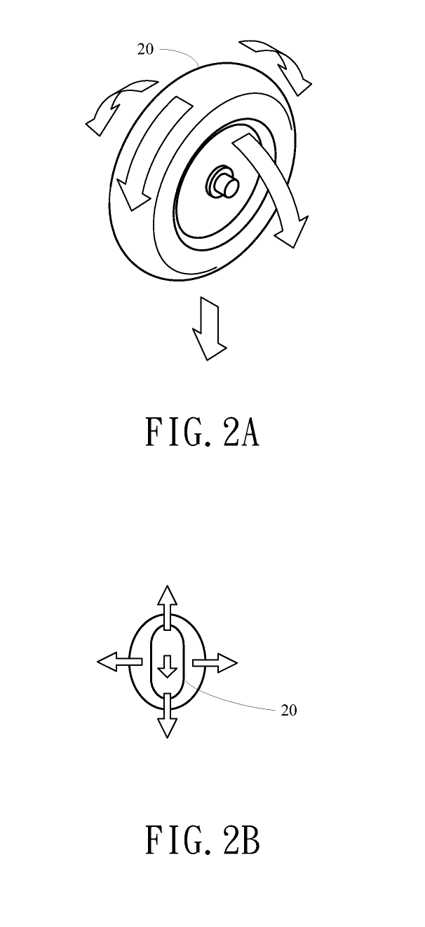

In a first embodiment of the present invention, a scroll wheel provides longitudinal scroll. Such kind of scroll wheel 20 is commonly seen in input devices such as mice. Based on different designs, the scroll wheel may also provide a triggering event when being pushed laterally or depressed, e.g. pushed to the left, pushed to the right or pushed down, as shown in FIGS. 2A and 2B. Therefore, in virtue of longitudinal scrolling and depress triggering, the scroll wheel may provide at least two dimensional triggering. For example, in the case of each dimensional triggering, display element groups or display elements can be selected via the scroll wheel and confirmation on the selections is made by the depress triggering that is equivalent to the selections of key groups or child key groups. Thus, the present invention can be applied to combinations of different dimensions.

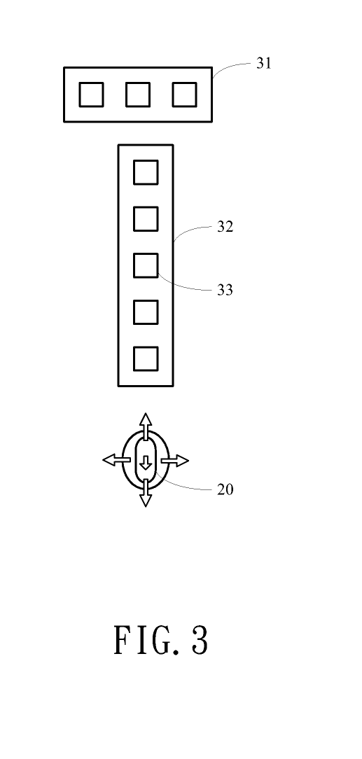

In FIG. 3, a set of first dimension display elements 31 and a set of second dimension display elements 32 are shown. When making a selection in the first dimension, it is switched between display elements in the first dimension display elements 31 by longitudinally scrolling the scroll wheel. When switching to a desired target, users may pause or depress the scroll wheel to confirm the first dimension selection. Similarly, when making a selection in the second dimension, it is switched between display elements in the second dimension display elements 32 by longitudinally scrolling the scroll wheel. When switching to a desired target, users may pause or depress the scroll wheel to confirm the second dimension selection.

In this embodiment, said depress triggering can be replaced by lateral triggering or pausing, such as pushing the scroll wheel to the left or right or pausing a certain period of time after switching to a desired target by longitudinal scrolling to confirm the selection. Moreover, in each of dimensional triggering mentioned above, the selection of a display element group or a display element can be achieved by longitudinal scrolling combined with lateral triggering.

Thus, in a second embodiment of the present invention, during a particular dimensional triggering, two selectable targets (a display element group or a display element) may be triggered in two ways: one is by pushing the scroll wheel to the left and the other is by pushing the scroll wheel to the right. Accordingly, during longitudinal scrolling of the scroll wheel, two targets are simultaneously selected (a display element group or a display element), then one of these two targets is further selected by lateral triggering of the scroll wheel (pushing it to the left or right), wherein confirmation of the selection is made at the same time the lateral triggering is taking place. One skilled in the art may easily appreciate that confirmation of target selection can be achieved by another triggering mechanism after lateral triggering has taken place, such as a depress triggering.

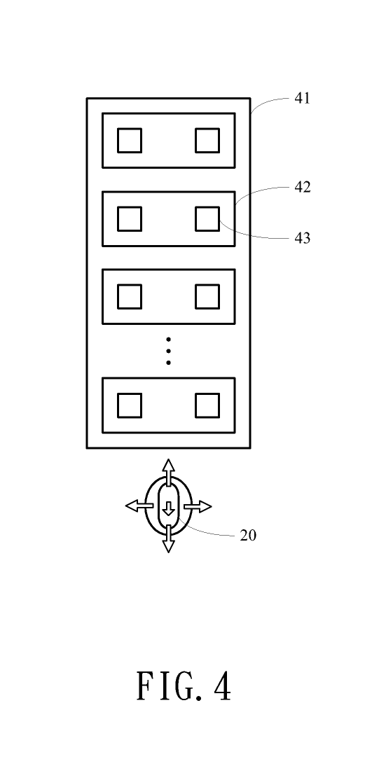

For example, a set of first dimension display elements 41 and multiple sets of second dimension display elements 42 are shown in FIG. 4, wherein each set of the second dimension display elements further comprises at least one display element 43. When making a selection in the first dimension, it is switched between the multiple sets of second dimension display elements 42 in the set of first dimension display elements 41 by longitudinally scrolling the scroll wheel. When switching to a desired target (one of the multiple sets of second dimension display elements 42), a second dimension selection may be done by lateral triggering, that is, a display element 43 in the selected set of second dimension display elements 42 is selected, for example, the left one is selected by pushing the scroll wheel to the left or the right one is selected by pushing the scroll wheel to the right.

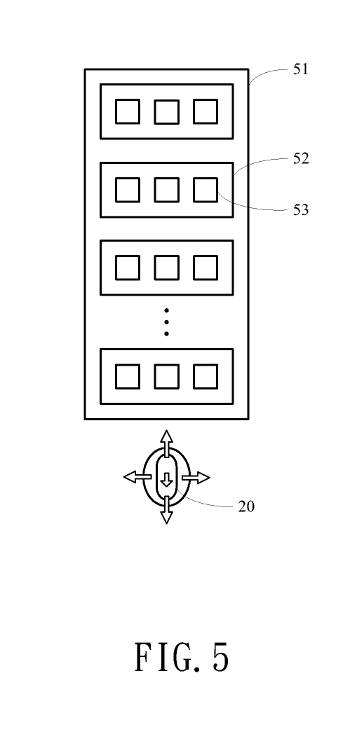

Accordingly, as shown in FIG. 5, a third embodiment of the present invention further comprises depress triggering. In FIG. 5, a set of first dimension display elements 51 including multiple sets of second dimension display elements 52 is shown, wherein each set of second dimension display elements 52 further includes a plurality of display elements 53. For example, each set of second dimension display elements 52 includes three display elements 53. One implementation of the present embodiment is making the first dimension selection via longitudinal scrolling of the scroll wheel, and when making the second dimension selection, the left one is selected by pushing the scroll wheel to the left; the right one is selected by pushing the scroll wheel to the right; the middle one is selected by depressing the scroll wheel. Alternatively, in another implementation of the present invention, the first dimension selection is made via longitudinal scrolling of the scroll wheel, and when making the second dimension selection, a display element 53 among the second dimension display elements 52 is selected by lateral triggering and subsequently depressing the scroll wheel.

It can be easily recognized by one skilled in the art that the above first dimension selection can be made more than once, i.e., a child display element group among the a display element group is selected in the first dimension selection process, thereafter, a grandchild display element group among the selected child display element group is selected in the next first dimension selection process.

It can also be easily recognized by one skilled in the art that abovementioned longitudinal scrolling, lateral and depress triggering of the scroll wheel can all be applied in the first dimension selection or the second dimension selection, wherein depress triggering can be achieved by a single click or double clicks. According to the present invention, the first dimension selection can be achieved not only by longitudinal scrolling, but also lateral and depress triggering. Similarly, the second dimension selection can be made by a combination of longitudinal scrolling, lateral and depress triggering.

Moreover, it can be easily recognized by one skilled in the art that when making a first dimension or second dimension selection, the display element group or display element being selected or switched to can make a display. When a display element group is selected or switched to, one display element representing that display element group, all display elements of that display element group or one of all display elements of that display element group can make a display. Alternatively, a backlight module covering the area of the display element group can be used for display. The present invention does not restrict the selections or display methods of the display element group or the display elements, relevant details of which can be easily derived and are therefore not detailed.

In addition, when a display element is displaying, power is consumed, which is significant particularly if the display is maintained continuously. Accordingly, in a fourth embodiment of the present invention, a vibration sensing element is further included to control the display element. When the vibration sensing element senses a vibration, the display element that requires display will be displayed for a certain period of time before the vibration sensing element turns off the display or senses another vibration, in the latter case, the display element is kept displaying.

A fifth embodiment of the present invention further includes a signal-sending element for sending a signal that represents a second dimension selection when the selection is confirmed. Since the second dimension selection is made after one or more first dimension selections, the signal that represents the second dimension selection can be regarded as a signal representing each of the first dimension selections and the second dimension selection. Sending a signal representing a selection made using an input device is a well known practice to one skilled in the art of signal-sending element, thus its relevant details will not be described.

Furthermore, the abovementioned display element may be an element that displays a plurality of pixels on a display device. The display device can for example be a screen, a LCD panel or other devices that can be used to render a pixel array. Each of the display elements above is a set of a plurality of pixels in a pixel array, which can therefore be used to represent the display of the display elements. These pixels may display a pattern that indicates a functionality represented by a display element. For example, each of the display elements above can respectively be a combination of a plurality of pixels displaying a pattern, so that when switching or selecting is made in the first or second dimension, the pattern that corresponds to the related display element will be displayed on the screen.

Additionally, the display element above may be a light-emitting element, e.g. a bulb, LED (applicable to the first preferred embodiment) or any other elements that can emit light. Thus, a simple circuit may be used to control each light-emitting element based on the signals sent by the signal-sending element. Compared to the example above using a screen to display the display elements, light-emitting elements have the advantages of simple circuit, low cost and power saving.

Accordingly, a sixth embodiment of the present invention is a scroll wheel controlling program stored in an input assembly with a processor. In order to allow a scroll wheel to be used as an input selection device, the input assembly with the processor is configured to be devices that have the following functionalities. A scroll wheel input device is provided that allows longitudinal scrolling and triggering, wherein the longitudinal scrolling provides a first dimension selection while the triggering provides a second dimension selection. A device is provided that switches between a multiple sets of first dimension display element groups based on the first dimension selection, wherein the multiple sets of first dimension display element are included in a plurality of display elements, and each set of first dimension display elements comprises at least a second dimension display element. A device is provided that switches between second dimension display elements of the selected first dimension display element group based on the second dimension selection. Other details of the present embodiment have been described above and will not be repeated.

Moreover, a seventh embodiment of the present invention is a recording medium stored with the scroll wheel controlling program. In order to make a scroll wheel an input selection device, the program allows the input assembly with the processor to be devices that have the following functionalities. A scroll wheel input device is provided that allows longitudinal scrolling and triggering, wherein the longitudinal scrolling provides a first dimension selection while the triggering provides a second dimension selection. A device is provided that switches between a multiple sets of first dimension display element groups based on the first dimension selection, wherein the multiple sets of first dimension display element groups are included in a plurality of display elements, and each set of first dimension display element groups comprises at least a second dimension display element. A device is provided that switches between the second dimension display elements of the selected first dimension display element group based on the second dimension selection. Other details of the present embodiment have been described above and will not be repeated.

The input assembly with the processor and the scroll wheel input device can be integrated into a man-machine interface for other devices, such as a remote controller, a mobile phone or a keyboard etc.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A scroll wheel input device, comprising:
a scroll wheel providing a longitudinal scrolling and a lateral triggering, wherein the longitudinal scrolling provides a first dimension selection and the lateral triggering provides a second dimension selection; and
a plurality of display elements comprising a multiple sets of first dimension display element group, each of the first dimension display element group comprising at least one second dimension display element, wherein the first dimension selection is made by switching among the different first dimension display element groups via the longitudinal scrolling while the second dimension selection is made by switching among the at least one second dimension display element in the switched first dimension display element group via the lateral triggering.

2. The scroll wheel input device of claim 1, wherein the at least one second dimension display element is displayed when switching to the first dimension display element group in which it is included.

3. The scroll wheel input device of claim 1, wherein when switching to the at least one second dimension display element, it is being displayed.

4. The scroll wheel input device of claim 1, further including a signal-sending element, wherein the scroll wheel further provides a depress triggering, wherein the depress triggering provides a confirmation for the second dimension selection, and the signal-sending element sending a signal representing the second dimension selection when the second dimension selection is confirmed.

5. The scroll wheel input device of claim 1, further including a signal-sending element, wherein when switching to a first dimension display element group having one second dimension display element, the second dimension selection becomes a confirmation for the first dimension selection, and the signal-sending element sending a signal representing the second dimension selection when the second dimension selection is confirmed.

6. The scroll wheel input device of claim 1, further including a signal-sending element, wherein when switching to a first dimension display element group having two second dimension display elements, the second dimension selection becomes a confirmation for the first dimension selection, and the signal-sending element sending a signal representing the second dimension selection when the second dimension selection is confirmed.

7. The scroll wheel input device of claim 1, further including a vibration sensing element, a display element displayed being stopped from displaying after the vibration sensing element fails to sense a vibration for a period of time.

8. The scroll wheel input device of claim 1, wherein the display element is a light-emitting diode.

9. The scroll wheel input device of claim 1, wherein the display element is a set of a plurality of pixels on a display device for display a pattern.

10. A recording medium stored with a scroll wheel controlling program, in order to make a scroll wheel an input selection device, the program allowing an input assembly with a processor to be devices that have the following functionalities:
providing a scroll wheel input device that allows a longitudinal scrolling and a lateral triggering, wherein the longitudinal scrolling provides a first dimension selection while the lateral triggering provides a second dimension selection;
providing a device that switches between a multiple sets of first dimension display element groups based on the first dimension selection, wherein the multiple sets of the first dimension display element groups are included in a plurality of display elements, and each set of the first dimension display element groups comprising at least one second dimension display element; and
providing a device that switches between the at least one second dimension display element of a switched first dimension display element group based on the second dimension selection.

11. The recording medium of claim 10, in order to make the scroll wheel an input selection device, the program further comprising allowing the input assembly with the processor to be a device that displays the at least one second dimension display element when switching to the first dimension display element group in which it is included.

12. The recording medium of claim 10, in order to make the scroll wheel an input selection device, the program further comprising allowing the input assembly with the processor to be a device that displays a second dimension display element when switching to the at least one second dimension display element.

13. The recording medium of claim 10, in order to make the scroll wheel an input selection device, the program further comprising allowing the input assembly with the processor to be a signal-sending element, wherein the scroll wheel input interface providing the longitudinal scrolling and the lateral triggering further provides a depress triggering, wherein the depress triggering provides a confirmation for the second dimension selection, and the signal-sending element sending a signal representing the second dimension selection when the second dimension selection is confirmed.

14. The recording medium of claim 10, in order to make the scroll wheel an input selection device, the program further comprising allowing the input assembly with the processor to be a signal-sending element, wherein when switching to a first dimension display element group having one second dimension display element, the device that switches between the at least one second dimension display element of a switched first dimension display element group based on the second dimension selection allowing the second dimension selection to become a confirmation for the first dimension selection, and the signal-sending element sending a signal representing the second dimension selection when the second dimension selection is confirmed.

15. The recording medium of claim 10, in order to make the scroll wheel an input selection device, the program further comprising allowing the input assembly with the processor to be a signal-sending element, wherein when switching to a first dimension display element group having two second dimension display elements, the device that switches between the at least one second dimension display element of a switched first dimension display element group based on the second dimension selection allowing the second dimension selection to become a confirmation for the first dimension selection, and the signal-sending element sending a signal representing the second dimension selection when the second dimension selection is confirmed.

16. The recording medium of claim 15, in order to make the scroll wheel an input selection device, the program further comprising allowing the input assembly with the processor to be a vibration sensing element that stops a display element from displaying after the vibration sensing element fails to sense a vibration for a period of time.

17. The recording medium of claim 10, wherein the display element is a light-emitting diode.

18. The recording medium of claim 10, wherein the display element is a set of a plurality of pixels on a display device for display a pattern.

19. A scroll wheel input device, comprising
a scroll wheel providing a longitudinal scrolling and a lateral triggering, wherein the longitudinal scrolling provides a selection and the lateral triggering provides a confirmation for the selection; and
a plurality of display elements, wherein the selection is made by switching among the different display elements via the longitudinal scrolling.

20. The scroll wheel input device of claim 19, further comprising a vibration sensing element that stops an illuminating display element from illuminating after the vibration sensing element fails to sense a vibration for a period of time, wherein the display element illuminates when being switched to.

21. The scroll wheel input device of claim 19, wherein the triggering takes place when the scroll wheel pauses for a period of time after being longitudinally scrolled.
